(19) United States
(12) Patent Application Publication
(10) Pub. No.: US 2008/0014354 A1
(43) Pub. Date: Jan. 17, 2008

(54) Color Balancer Treatment for Automotive Bodies

(76) Inventors: Steven E. Farrell, Syracuse, NY (US); Michael W. Burke, Cicero, NY (US)

Correspondence Address: Bernhard P. Molldrem, Jr., 224 Harrison Street, Syracuse, NY, 13202, US

(21) Appl. No.: 11/773,511

(22) Filed: Jul. 5, 2007

Related U.S. Application Data
(60) Provisional application No. 60/830,384, filed on Jul. 13, 2006.

(51) Int. Cl. B05D 3/00; C04B 14/00; C08L 1/12; C09C 1/44

(52) U.S. Cl. 427/299; 106/171.1; 106/400; 106/472

(57) ABSTRACT

A color balancer composition achieves a change in tone or hue on a vehicle painted surface as needed to achieve an acceptable color fade to match an adjacent area. The composition is composed of a clear coat, a toner or colorant, and a reducing agent. The color balancer composition is formed by mixing these three parts. In one implementation, one part of the colorant is blended with about 100 parts of the clear coat, and then the resulting blend is combined at about 4 parts by volume of the reducing agent with one part of the colorant-clear coat mixture. The ratios can be varied.

Applicants claim priority of Provisional Application No. 60/830,384, Jul. 13, 2006.

### BACKGROUND OF THE INVENTION

The invention concerns a product and process for matching the tones and hues of painted surfaces, especially body panels, bumpers, doors, hoods, and other painted parts of a vehicle body.

Where paint color is slightly lighter on one body part than on another adjacent body part, e.g., where a re-painted trunk or hood is slightly different in tone from the fenders or other body panels, this color difference becomes noticeable at the edge where the body parts meet. This is also true for small areas of a body panel or bumper that are repainted, and the repainted portions do not quite match the color of the undamaged portions.

The only option at present is to repaint, or blend or re-clear the entire item. However, what is needed is a means for slightly changing the color of either the repainted part or the adjacent part, just at the edge area, so that the color differences are no longer noticeable.

### OBJECTS AND SUMMARY OF THE INVENTION

Accordingly, it is an object of this invention to provide a simple process for applying a color balancer that neutralizes the slight differences in tone or hue between the refinished or repainted portions and the original portions of the motor vehicle body.

It is another object to provide a composition that can be easily applied, where needed, e.g., by spraying directly onto the affected areas, to neutralize the aforementioned color differences. It is a further object of the invention to provide a color balancer composition that can be applied without needing to pre-sand, pre-scrape or other preparatory steps beyond cleaning and masking around the affected area, i.e., the area in which a change of tone or hue is needed.

According to an aspect of this invention, a color balancer composition is composed of a clear coat., i.e. clear;, a toner, i.e., a colorant and a reducing agent, and this is applied by first cleaning and masking the affected area; spraying the color balancer onto the affected area, i.e., the area in which a change of tone or hue is needed; permitting the color balancer to set and dry; and then buffing that area of the body panel, bumper, door, etc., as needed to achieve an acceptable color fade.

The product is applied by first cleaning the area where the look or color is not desirable. The area surrounding the portion to be sprayed is masked off, e.g., with masking tape or other blocking agents, as are all adjacent panels and all non-painted surfaces. The area to be sprayed with the product could be left unscraped, unsanded, unabraded, unscuffed and not altered. Then the product is sprayed as needed onto the affected portion of the body panel,bumper, etc. After the area has been sprayed, the area can be hand buffed or machine buffed, if required, to achieve a color fade. Generally, the area to be sprayed is only a few inches across, which eliminates the “edge” of color change, so the color differences are no longer noticeable.

The color balancer is formed of a mixture of three parts, i.e., a clear coat or clear finish, a colorant (i.e., the pigment portion or darkener) and a reducer agent. In one implementation, one part of the colorant is blended with about 100 parts of the clear coat, and then the resulting blend is combined at about 4 parts by volume of the reducing agent with one part of the colorant-clear coat mixture. The ratios can be varied.

In one version of this, the pigment is carbon black and is used for slightly darkening the lighter painted area. However, in other versions, where the hue is found to be slightly off between the two adjacent painted areas, a color pigment can be used to make the one area more or less intense in that color. In other versions, a metallic agent can be included.

The above and many other objects, features, and advantages of this invention will become apparent from the ensuing detailed description of a preferred embodiment.

### DETAILED DESCRIPTION OF ONE PREFERRED EMBODIMENT

One specific example of the invention is as given:

(concentrations given as percent, by weight)

Part I (clear coat or clear finish)

### Butyl acetate (38-48); cellulose acetate butyrate (5-15); ethyl benzene (2.2-5.5); methyl isobutyl ketone (9); methyl ethyl ketone (15); xylene (15-20); acrylic polymer (16-26)

Part II (reducer agent)

### Xylene (14-17); ethyl benzene (1.9-4.6); propylene glycol monomethyl ether acetate (27-37); isopropyl alcohol (5-15); toluene (15); methyl isobutyl ketone (15); methyl ethyl ketone (14); acrylic polymer (5-15)

Part III (colorant)

### Xylene (28-33); ethyl benzene (3.7-9.3); butyl acetate (5-15); carbon black (4.5); acrylic polymer (38-48)

The product is formed by mixing (in parts, by weight) one portion of Part I with 0.005 to 0.015 portions Part III (the amount of Part III depending on the shade desired). Then, that product is mixed with the Part II, in the ratio of four part of Part II to each one part of the Part II-Part III mixture.

Either in place of the carbon black, or in addition, pigments of the body paint used in the body paint job can be used in the colorant of Part III.

When this product is applied onto a painted automotive body surface, either metal or plastic, the product adheres with the painted surface of the affected portion of body part, and achieves a gentle darkening effect on the area, with the result that the re-painted area and the adjacent original painted surface now appear to be the same shade.

An area of about four inches, more or less, is all that is needed, and this is masked off before spraying. The remainder of the vehicle is protected from overspray. Usually, about 12 inches of paper is needed to catch the overspray. The area is sprayed, and the product dries in a few minutes. Then the masking agent is removed, and the perimeter of the sprayed area is buffed as need be so that the shade of the sprayed area fades or blends into that of the remainder of the affected body part.

The entire process from cleaning, to masking, to spraying, typically takes only minutes. Also, when this is performed routinely after repainting an automotive body part, the repainting and repair process is kept as short as possible. When the process and product of this invention are employed, a re-paint (i.e., painting of the area in which a change of tone or hue is needed) pertaining to the entire body part, e.g., an entire door panel or an entire bumper, is not necessary to correct small differences in paint color or tone.

The effect of the above-described process and product is to make color matching easier for the body shop professional; to save the shop (and insurance companies) hundreds of dollars on repair jobs; provide a solution that is simple and easy to apply, as well as being very quick; minimalization of waste and clean-up; chemical bonding for excellent adhesion for all or nearly all OEM and painted surfaces, and creating a nearly invisible edge; elimination of the need to sand the affected area; short drying time; good results on all colors.

A typical color balancing kit can include packages or canisters of a color balance cleaner; a light balancer for very slight color differences; a medium balancer for more noticeable color differences; and a dark balancer for use on darker colors.

While the invention has been described here with reference to a preferred embodiment, the invention is not limited only to that embodiment. Rather, many modifications and variations will be apparent to those skilled in the art, without departing from the scope and spirit of this invention, as defined in the appended claims.

1. A process of minimizing noticeable color difference between repainted and original painted surfaces of a vehicle body, comprising:
cleaning an area of one or the other of the repainted and original painted surfaces;
protecting adjacent surfaces;
applying a color balancer agent to said area; and
permitting the color balancer agent to dry.

2. The process of minimizing color differences according to claim 1, further comprising buffing a perimeter of said area after the color balancer has been permitted to dry.

3. The process of minimizing color differences according to claim 1, wherein said step of protecting includes masking off around said area.

4. A color balancer agent that is adapted to be sprayed onto a painted vehicle body surface to modify the tone thereof, comprising a clear coat; a colorant; and a reducing agent.

5. The color balancer agent of claim 4, wherein said clear coat and said colorant are blended together in amounts of one part clear coat to 0.005 to 0.015 parts colorant; and the resulting mixture is blended one part thereof with four parts of said reducing agent.

6. The color balancer agent of claim 4, wherein said colorant includes carbon black.

7. The color balancer agent of claim 4, wherein said colorant includes pigments of said painted vehicle body surface.

8. The color balancer agent of claim 4, wherein said clear coat includes:
butyl acetate; cellulose acetate butyrate; ethyl benzene; methyl isobutyl ketone;
methyl ethyl ketone; xylene; and acrylic polymer;
said reducing agent includes:
xylene; ethyl benzene; propylene glycol monomethyl ether acetate; isopropyl alcohol; toluene; methyl isobutyl ketone; methyl ethyl ketone; and acrylic polymer; and
said colorant includes:
xylene; ethyl benzene; butyl acetate; pigment; and acrylic polymer.
